(19) United States
(12) Patent Application Publication
(10) Pub. No.: US 2025/0055121 A1
(43) Pub. Date: Feb. 13, 2025

(54) BATTERY ARRANGEMENT WITH A HEAT PROTECTION LAYER AND MOTOR VEHICLE

(71) Applicant: AUDI AG, Ingolstadt (DE)

(72) Inventors: Tobias GIER, Ludwigsburg (DE); Philipp SELLE, Heilbronn (DE)

(73) Assignee: AUDI AG, Ingolstadt (DE)

(21) Appl. No.: 18/797,644

(22) Filed: Aug. 8, 2024

(30) Foreign Application Priority Data
Aug. 11, 2023 (DE) 102023121525.6

(51) Int. Cl. H01M 50/358; H01M 10/04; H01M 10/625; H01M 10/658; H01M 50/204; H01M 50/249

(52) U.S. Cl. CPC H01M 50/358; H01M 10/0481; H01M 10/625; H01M 10/658; H01M 50/204; H01M 50/249; H01M 2200/20; H01M 2220/20

(57) ABSTRACT

A battery arrangement with a heat protection layer, including a battery module with at least one battery cell which has a releasable cell degassing opening and a first module side, a partial region of which represents a degassing region in which the releasable cell degassing opening is arranged, and a degassing channel wall which has a first wall side opposite the first module side with respect to a first direction, which includes an inlet region which is opposite the degassing region with respect to the first direction. The inlet region includes a predetermined passage point opposite the cell degassing opening with respect to the first direction and a surface adjacent thereto.

### FIELD

The invention relates to a battery arrangement with a heat protection layer, wherein the battery arrangement has a battery module with at least one battery cell which has a releasable cell degassing opening, wherein the battery module has a first module side, wherein a partial region of the first module side represents a degassing region in which the releasable cell degassing opening is arranged, and wherein the battery arrangement has a degassing channel wall which has a first wall side opposite the first module side with respect to a first direction, which comprises an inlet region which is opposite the degassing region with respect to the first direction. Furthermore, the invention also relates to a motor vehicle.

### BACKGROUND

Battery cells, for example of high-voltage batteries or battery modules, in particular for motor vehicles, typically have a releasable cell degassing opening. If thermal runaway occurs in such a battery cell, the excess pressure created in the battery cell can be released via the releasable cell degassing opening. This usually results in gas escaping from the cell degassing opening which is thus released. Gas escaping from such a thermally runaway battery cell can also be discharged via a degassing channel. Such a cell degassing channel can accordingly have an inlet region through which the gas escaping from the released cell degassing opening can enter the degassing channel. Such a degassing channel should ideally be connected as closely as possible to the cell degassing openings of the battery cells in order to prevent part of the gas from escaping between the degassing channel and the outgassing battery cell. In addition, the gas escaping from a battery cell should be kept as far away as possible from neighboring cells and their cell degassing openings in order to prevent propagation to neighboring cells. Otherwise, the gas escaping from the thermally runaway cell can lead to a strong heating of the neighboring cells, which can also thermally runaway.

In order to connect such a degassing channel as well as possible to the cell degassing openings, an appropriate seal could be used. However, seals generally have the problem that they are not particularly temperature-resistant and can therefore melt when hot gases escape from the cell, thereby losing their sealing effect. A further problem is that in order to provide a sufficient sealing effect, a certain compression of such a seal is required between the two components to be sealed. On the other hand, there is also a requirement to save space and weight. For this purpose, components such as the degassing channel walls of a degassing channel are preferably designed to be as thin-walled as possible. If such a thin degassing channel wall is arranged over a seal on the battery module, it cannot exert the necessary contact force on the seal to achieve a sufficient sealing effect, but instead is itself bent, in particular in the direction away from the cell degassing openings or the seal. This also makes it more difficult to attach such a degassing channel to the battery module, since the restoring forces generated by the compressed seal can not only lead to a deformation of the degassing channel wall, but also to an impairment or stress on the fastening points. The sealing connection of such a degassing channel to a battery module has so far been very complex and in particular leads to a very massive and complex design of the components involved.

US 2014/0234677 A1 describes a battery module with a plurality of battery cells, each having a cover plate having a terminal region and a cell degassing opening region. Furthermore, the battery module comprises a cover covering the cell degassing opening regions and a heat resistance member between the battery cells and the cover, wherein the heat resistance member has an opening in a region corresponding to a respective cell degassing opening region. The heat resistance component can be arranged between the battery cells and an insulation component. The heat resistance component can be designed as a ceramic plate. The cover can have the shape of a hexagon which is open on one side. The open side faces the cell degassing opening regions. The cover can rest directly on the insulation component. The cover also defines a gas flow path to an outlet opening. The insulating component can be designed as a seal made of a heat-resistant material. The heat resistance component can be designed with a raised edge surrounding the cell degassing openings, which edge extends through the recesses in the insulation component corresponding to the cell degassing opening regions in order to protect the insulation component laterally from the hot gas.

However, the problems mentioned above still remain.

### SUMMARY

The object of the present invention is therefore to provide a battery arrangement and a motor vehicle which enable a degassing channel wall to be connected to a battery module as efficiently and tightly as possible and at the same time allow the components involved to be designed as simply, space-savingly and cost-effectively as possible.

A battery arrangement according to the invention with a heat protection layer has a battery module with at least one battery cell which has a releasable cell degassing opening, wherein the battery module also has a first module side, wherein a partial region of the first module side represents a degassing region in which the releasable cell degassing opening is arranged. In addition, the battery arrangement comprises a degassing channel wall having a first wall side opposite the first module side with respect to a first direction, which first wall side comprises an inlet region opposite the degassing region with respect to the first direction. The inlet region has a predetermined passage point opposite the cell degassing opening with respect to the first direction, and a first surface which adjoins the predetermined passage point, wherein between the degassing region and the inlet region there is an intermediate space in which the heat protection layer is arranged with compression of the heat protection layer with respect to the first direction, and wherein the battery arrangement comprises at least one linear pressure element which is arranged such that the compression of the heat protection layer is locally increased in the region between the first surface of the inlet region and the first module side.

The invention is based on several findings: by means of such a heat protection layer between the degassing channel wall and the first module side of the battery module, a certain sealing of the degassing channel or the degassing channel wall with respect to the first module side can advantageously be provided in the event of gas escaping from a thermally runaway battery cell. Because the heat protection layer is arranged under a certain compression with respect to the first direction in the intermediate space between the degassing region and the inlet region, this sealing effect can be provided in a particularly efficient and very effective manner. However, such compression causes a certain restoring force on the adjacent components, which in this case are the degassing channel wall and the first module side. By providing a linear pressure element, it is now possible to locally increase the compression of the heat protection layer. As a result, the sealing effect of the heat protection layer is also increased, especially in the region of this locally increased compression. In other regions of the heat protection layer, the compression of the heat protection layer is therefore lower. By providing such a pressure element, the restoring forces resulting from the compression of the heat protection layer on the components involved can now advantageously be reduced on average without impairing the sealing effect of the heat protection layer; on the contrary, the sealing effect can be increased by the locally increased compression of the heat protection layer in those regions in which it is advantageous and predetermined. Especially in the region between the first surface of the inlet region on the one hand, wherein this first surface borders on the predetermined passage point in the entry region, and the first module side on the other hand, the heat protection layer can be provided with increased compression and thus with improved sealing effect. Consequently, an increased sealing effect can be provided in regions of the heat protection layer adjacent to the predetermined passage point, e.g. also all around this predetermined passage point. Since the restoring forces acting from the heat protection layer on the adjacent components, in particular on the degassing channel wall, can be reduced by only locally increasing the compression of the heat protection layer, the degassing channel wall can be designed very simply and with thin walls without having to fear deformation of the degassing channel wall, which in turn would impair the tightness. Due to the reduced restoring forces, this also facilitates the connection of the degassing channel wall to the battery module via suitable connection or fastening regions. As explained in more detail later, the degassing channel wall can, for example, be partially glued to the first side of the module using an adhesive. The restoring forces exerted by the heat protection layer on the degassing channel wall do not affect or mechanically stress these adhesive points and thus enable a particularly simple and stable connection of the degassing channel wall to the battery module. Overall, this makes it possible to provide a tight connection between the degassing channel wall and the battery module, which at the same time enables a very simple, cost-effective and space-saving design of the components involved.

The heat protection layer is made of a compressible material. Optionally, the material of the heat protection layer or the heat protection layer as such can also be elastically compressible. The heat protection layer can be provided in the form of a heat protection mat and/or a heat protection foam or a foam layer or the like. The heat protection layer can also be designed to be continuous, so that the releasable cell degassing opening on the one hand and the corresponding predetermined passage point on the other hand are covered by the heat protection layer. The heat protection layer is preferably made of a material that is as heat-resistant as possible, but which can be destroyed locally by a gas that escapes from the released cell degassing opening of the battery cell. If, for example, a gas escapes from the releasable cell degassing opening of the battery cell, this gas can locally penetrate the heat protection layer underneath in the outlet direction with respect to the first direction, hit the predetermined passage point of the inlet region of the degassing channel wall and penetrate through the predetermined passage point into the degassing channel, which is delimited by the degassing channel wall with respect to the first direction. The heat protection layer is thus designed in such a way that it is locally destroyed in a gas passage region, which is defined as the region which is arranged directly between the releasable cell degassing opening and the underlying predetermined passage point with respect to the first direction, but is not destroyed or remains largely intact in regions which border this gas passage region in the lateral direction, i.e. perpendicular to the first direction. As a result, the heat protection layer can provide a sealing effect between the degassing channel wall and the first module side, which is maintained even in the event of degassing in regions adjacent to the gas passage region. Consequently, this can also provide a thermal and mechanical barrier to the cell degassing openings of adjacent battery cells, for example when the battery module comprises multiple battery cells.

Increased compression means that the compression of the heat protection layer in the region of this increased compression is higher than in immediately adjacent or other regions of the heat protection layer. In these adjacent or other regions, the heat protection layer does not necessarily have to be compressed, but it can be. The heat protection layer is therefore more compressed in the region of increased compression. The heat protection layer, for example, has an increased density in the region of increased compression. Preferably, the compression of the heat protection layer is maximum in the region of increased compression. Accordingly, the density of the heat protection layer can then be highest in the region of increased compression. The heat protection layer is also designed to be compressible, for example elastic and/or elastically compressible, wherein a particularly good sealing effect can be achieved precisely through elastic compressibility.

The predetermined passage point can be designed as an opening in the degassing channel wall that leads into the interior of the degassing channel or as a predetermined breaking point, which can also include such an opening, which is normally closed and only opens in the event of degassing due to the gas hitting the predetermined breaking point. The design as a predetermined breaking point is preferred. In addition, a predetermined passage point should be understood as an extended region of he degassing channel wall and not just a point. The shape and size of the predetermined passage point can correspond to the shape and size of the associated, releasable cell degassing opening.

The battery module can generally comprise not only one battery cell, but also multiple battery cells. The battery cells can be designed as prismatic battery cells or round cells or pouch cells, but are preferably designed as prismatic battery cells. Moreover, the battery cells can be formed as lithium-ion cells, for example. The releasable cell degassing opening of the battery cell can, for example, be designed as a predetermined breaking point or as a pressure relief valve. In particular, the releasable cell degassing opening can be embodied as a bursting membrane. In general, a releasable cell degassing port is an opening that is closed by a shutter and that is released under a certain condition, in particular by opening the shutter. The releasable cell degassing opening of the battery cell is also preferably designed as a passive and pressure-dependent releasable cell degassing opening. The battery cell can, for example, have a first cell side on which such a releasable cell degassing opening is arranged. The first cell side can represent part of the first module side.

A high-voltage battery, in particular a high-voltage battery for a motor vehicle can be provided by this battery arrangement. Such a high-voltage battery can also comprise not only one battery module, but also multiple battery modules.

The degassing channel wall can be part of a degassing channel or be provided for such a degassing channel. The degassing channel wall may also be referred to as a first degassing channel wall, and a second degassing channel wall may be provided as part of the degassing channel, which is opposite to the first degassing channel wall with respect to the first direction. The interior of the degassing channel can then be formed accordingly between the first and the second degassing channel wall. The second degassing channel wall can be provided, for example, by an underride guard of the motor vehicle. With respect to a preferred installation position of the battery arrangement in a motor vehicle, the releasable cell degassing opening of the battery cell is directed downwards, i.e. the first module side faces a base of the motor vehicle on which the motor vehicle is located. Nevertheless, it is also conceivable that the cell degassing opening is directed upwards and is accordingly facing away from the base of the motor vehicle. Furthermore, it is preferred that the cell poles of the battery cell are not arranged on the first cell side on which the releasable cell degassing opening is arranged. This facilitates the connection of the first degassing channel wall to the first module side.

The inlet region of the first wall side of the degassing channel wall represents a region through which a gas escaping from a thermally runaway battery cell enters the interior of the degassing channel.

The inlet region of the first wall side comprises the predetermined passage point, but also a region different from the releasable predetermined passage point, the surface of which represents the first surface adjacent to the predetermined passage point. The first surface can also be defined circumferentially around the first predetermined passage point and adjacent to it. The first surface can be defined, for example, as all those surface regions of the inlet region that are different from the at least one predetermined passage point. In these regions, which belong to the first surface, no predetermined passage point should be arranged. This also applies in the case of several predetermined passage points if the battery module comprises multiple battery cells.

A linear pressure element is understood to mean a pressure element which runs along a line, whereby this line can have two open ends or can be designed as a closed line, i.e. as a circle or oval or a closed curve with any curvature. In addition, the pressure element has a certain dimension, i.e. width, perpendicular to its direction of extension along the line, which is finite but significantly smaller than the length of the pressure element along the line, i.e. along its extension. Furthermore, the linear pressure element does not have to run along a straight line, but can also run along any curved line.

In a further advantageous embodiment of the invention, the locally increased compression of the heat protection layer caused by the linear pressure element extends along a line that partially or completely encircles the predetermined passage point, which in particular represents an opening and/or predetermined breaking point in the inlet region, in particular viewed in a vertical projection of this line of locally increased compression with respect to the first direction onto the inlet region. Since the heat protection layer is located above the inlet region with the predetermined passage point with respect to the first direction, the course of increased compression of the heat protection layer is to be understood in a vertical projection with respect to the first direction onto the inlet region. The region with the increased compression of the heat protection layer, when projected vertically in the first direction onto the inlet region of the first wall side, results in a line on this inlet region which extends partially or completely around the predetermined passage point in the inlet region. In this way, an increased sealing effect of the heat protection layer can be achieved specifically around the region of the predetermined passage point.

In a further very advantageous embodiment of the invention, the pressure element is designed as an elevation of the first surface of the inlet region. The pressure element can therefore be designed as an elevation in the first wall side of the degassing channel wall itself. If the degassing channel wall has an elevation on its first surface in the region of the inlet region, this elevation automatically leads to an increased compression of the heat protection layer lying above it, which is in particular flat and, in the uncompressed state, uniformly thick. Such an elevation can therefore provide a locally increased compression of the heat protection layer in a particularly simple manner. The same design options apply to this local elevation in the first surface as described for the region with increased compression of the heat protection layer. In other words, the elevation of the first surface of the inlet region can extend along a line that partially or completely encircles the predetermined passage point in the inlet region, in particular along an edge region of this predetermined passage point, or the local elevation can also partially or completely form the edge region of this predetermined passage point. The design of the pressure element as an elevation of the first surface of the inlet region also has the great advantage that the formation of such an elevation in the surface of the degassing channel wall simultaneously causes a stiffening of the degassing channel wall in this region. Due to the increased rigidity, the restoring forces generated by the heat protection layer can in turn be counteracted by an increased counterforce. This in turn makes it possible to efficiently avoid bending of the degassing channel wall, especially in this region where an increased sealing effect is to be achieved, in particular without designing the entire degassing channel wall with a higher wall thickness or more robust. This in turn saves space and weight.

In a further advantageous embodiment of the invention, the elevation of the first surface is designed as an embossed portion of the degassing channel wall pointing in the direction of the first module side. Such an embossing of the degassing channel wall has the advantage that it can be provided by a local curvature of the degassing channel wall in this region without increasing the wall thickness of the degassing channel wall in the region of the embossing. In other words, the elevation in the surface can be provided by appropriately embossing or bulging the degassing channel wall in this region. On the second side of the degassing channel wall opposite the first wall side, which faces the interior of the degassing channel, a corresponding depression or groove is formed in the degassing channel wall at the location of the embossing. This makes it particularly easy to provide the elevation in the surface and also saves weight.

According to a further very advantageous embodiment of the invention, the elevation of the first surface represents a closed edge region surrounding the predetermined passage point. This allows the predetermined passage point to be sealed all around with respect to the releasable cell degassing opening.

In a further very advantageous embodiment of the invention, the degassing channel wall comprises a wall component, in particular a sheet metal, in which a passage opening is arranged, which is opposite the cell degassing opening with respect to the first direction, wherein the pressure element is designed as an elevation of the first surface that partially or completely surrounds the passage opening, in particular wherein the degassing channel wall has a predetermined breaking cover element, which is arranged on the degassing channel wall so as to cover the passage opening, and the part of which covering the passage opening provides the predetermined passage point in the form of a predetermined breaking point.

The wall component of the degassing channel wall is preferably designed as a metal sheet, i.e. as a very thin metallic plate. In principle, the wall component can also be made of another material, for example plastic or something similar. In this wall component, in particular plate-shaped wall component, a passage opening can be arranged directly opposite the releasable cell degassing opening of the battery cell. This is preferably covered by the aforementioned cover element, the predetermined breaking cover element. This can be, for example, a thin plastic film or a plastic component, such as a thin plastic plate. Preferably, the predetermined breaking point covering element has a lower melting point than the wall component. As a result, the degassing channel wall can be very easily penetrated by a gas stream escaping from the battery cell, especially in the region of this predetermined breaking cover element or its part covering the passage opening. The part of the predetermined breaking point cover element covering the passage opening thus represents the predetermined breaking point of the degassing channel wall. It is now very advantageous if the pressure element surrounds the passage opening in the wall component as a partially or completely circumferential elevation of the first surface. The cover element can be arranged on a side of the wall component facing the battery module or on the side facing away from the battery module. An arrangement on a side facing the battery module is preferred. It is particularly advantageous if the pressure element represents, for example, the edge region of the passage opening. In other words, the edge of the first surface immediately adjacent to the passage opening is raised, thus providing the pressure element.

In a further advantageous embodiment of the invention, the first wall side has a first and a second contact region, wherein the inlet region is arranged between the first and second contact regions with respect to a second direction which is perpendicular to the first direction, wherein the inlet region is recessed relative to the first and second contact regions with respect to the first direction. Due to the recessed design of the inlet region compared to the contact regions, it is advantageously possible to form the intermediate space in which the heat protection layer is arranged. The heat protection layer therefore does not extend across the two contact regions. This advantageously makes it possible to connect the degassing channel wall to the battery module via the contact regions. The connection is preferably made via an interface material, for example an adhesive. The connection can also be a thermal connection, for example by means of a thermal interface material. This can be a thermally conductive adhesive and/or a so-called gap filler, namely a gap filler that is a curable thermally conductive compound. Between a respective contact region and the region of the first module side opposite with respect to the first direction, the said adhesive is preferably arranged as an interface material, for example. Such an interface material can extend over a large area across the entire contact region or across both contact regions.

The connection via a thermal interface material is very advantageous, for example, if the degassing channel wall simultaneously provides a cooling device for cooling the battery module. For this purpose, the degassing channel wall can also have integrated cooling channels through which a liquid coolant can flow. For this purpose, the degassing channel wall can be designed with several layers, for example wall surfaces, between which the coolant channels are formed. The coolant channels are thus spatially and fluidically separated from the interior of the degassing channel, which is delimited by the degassing channel wall.

In a further advantageous embodiment of the invention, the pressure element is designed as a linear elevation of a second surface of the heat protection layer. This also makes it possible to achieve a locally increased compression of the heat protection layer. The heat protection layer can therefore, for example, be designed with a basically substantially flat second surface which has a local, linear elevation or bump through which the pressure element is provided. This linear elevation of the second surface can be designed or arranged in the same way as described, for example, for the elevation of the surface of the first wall side in the inlet region. In other words, this linear elevation on the heat protection layer is positioned in such a way that it can provide a locally increased compression, which preferably seals the predetermined passage point in the degassing channel wall completely all the way around.

Such a linear elevation of the second surface of the heat protection layer can also be combined with the previously mentioned example, according to which the pressure element is designed as part of the degassing channel wall. The pressure element is then to be regarded as an additional pressure element, for example as a second pressure element.

The second surface of the heat protection layer can face the degassing channel wall and/or the first module side. Also, both surfaces of the heat protection layer, for example the one facing the battery module and the one facing the degassing channel wall, can be designed with such a pressure element.

In a further advantageous embodiment of the invention, the battery module has a plurality of battery cells with respective releasable cell degassing openings, which are arranged in the degassing region of the first module side, wherein the first wall side has an associated predetermined passage point for each cell degassing opening, and wherein the inlet region is divided in a third direction into multiple sub-regions, each of which comprises exactly one of the predetermined breaking points, wherein the battery arrangement comprises a linear pressure element for each cell degassing opening, so that the compression of the heat protection layer is locally increased in the region between the first surface of a respective sub-region of the inlet region and the first module side.

The third direction can be defined perpendicular to the first and second directions. According to this design, the battery module thus comprises multiple battery cells. The design of the battery module, the degassing channel wall and the heat protection layer can be completely analogous in the case of multiple battery cells as already described for the battery module with one battery cell. The heat protection layer is preferably designed as a continuous layer that covers all predetermined breaking points and all accessible cell degassing openings.

Furthermore, the invention also relates to a motor vehicle having a battery arrangement according to the invention or one of its embodiments.

The advantages mentioned for the battery arrangement according to the invention and its starting configurations thus apply similarly to the motor vehicle according to the invention.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic cross-sectional illustration of a battery arrangement according to an exemplary embodiment of the invention;

FIG. 2 shows a further schematic cross-sectional illustration of the battery arrangement of FIG. 1 according to an exemplary embodiment of the invention;

FIG. 3 shows a schematic and perspective illustration of a degassing channel wall for a battery arrangement according to an exemplary embodiment of the invention; and

FIG. 4 shows a schematic and perspective illustration of a part of the degassing channel wall from FIG. 3 according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

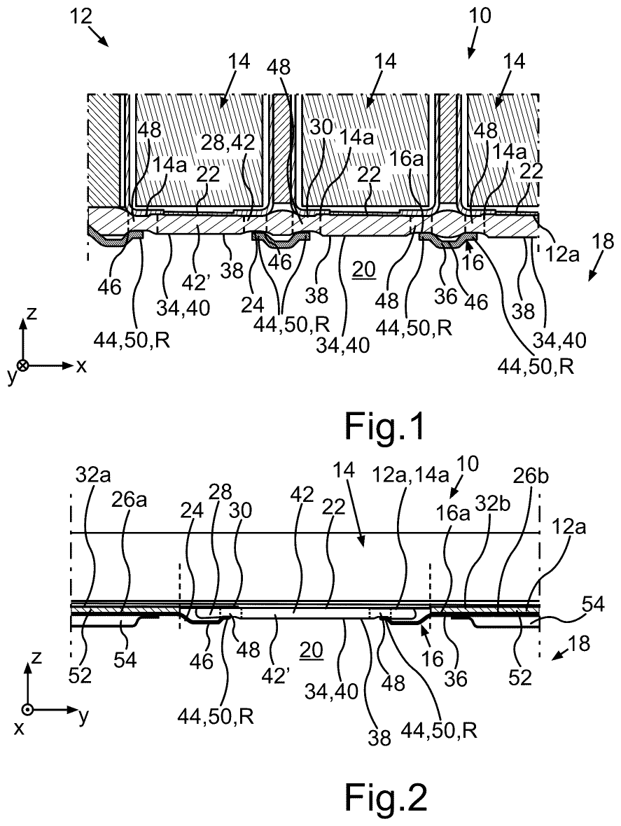

FIG. 1 shows a schematic cross-sectional illustration of a battery arrangement 10 according to an exemplary embodiment of the invention. In particular, only a part of such a battery arrangement 10 is shown here. The battery arrangement 10 in this example comprises a battery module 12, which in turn comprises multiple battery cells 14, of which three are shown here. The battery module 12 has a first module side 12a which faces a degassing channel wall 16 of a degassing channel 18 with respect to a first direction corresponding to the z-direction shown. The degassing channel wall 16 is also part of the battery arrangement 10. The degassing channel wall 16 spatially delimits the battery module 12 from an interior 20 of the degassing channel 18.

A respective battery cell 14 has a first cell side 14a, which in this case represents a cell bottom side 14a. In addition, each battery cell 14 as a cell of the first cell side 14a comprises a releasable cell degassing opening 22. This can also be referred to as cell vent 22 or venting opening 22. In the event of a thermal runaway of a battery cell 14, such a releasable cell degassing opening 22 opens in a pressure-dependent and passive manner and thus enables outgassing of the battery cell 14. The escaping gas can be introduced into the cell degassing channel 18, as explained in more detail later. The degassing channel wall 16 has a first wall side 16a which faces the battery module 12.

FIG. 2 shows a schematic representation of another cross section of the battery arrangement 10 from FIG. 1. In particular, FIG. 1 shows a cross section perpendicular to the x-direction shown, while FIG. 1 shows a cross section perpendicular to the y-direction. FIG. 2 shows in particular the cross section through a battery cell 14 in the region of its cell degassing opening 22. The degassing channel wall 16 or the first wall side 16a can be divided into three regions in the y-direction, the region boundaries of which are illustrated in FIG. 2 by dashed lines. As such regions, the first wall side 16a has a central region, which represents an inlet region 24, as well as two connection regions 26a and 26b. The inlet region 24 is arranged in the y-direction between the two connection regions 26a, 26b. The degassing channel wall 16 is recessed in the inlet region 24 compared to the connection regions 26a, 26b. This results in an intermediate space 28 between the inlet region 24 and the corresponding region of the first module side 12a, which is opposite in the z-direction. This partial region of the first module side 12a, which is opposite in the z-direction, is also referred to as the degassing region 30. The releasable cell degassing openings 22 of the battery cells 14 are arranged in this part of the first module side 12a, namely the degassing region 30. The first module side 12a can also be divided into three partial regions, the subdivision of which is illustrated by the dashed lines shown. In addition to the cell degassing region 30, the first module side 12a also comprises a first partial region 32a and a second partial region 32b. The degassing region 30 is arranged between the first and second partial regions 32a, 32b. The first partial region 32a is opposite the first connection region 26a with respect to the z-direction and the second partial region 32b is directly opposite the second connection region 26b with respect to the z-direction. Accordingly, the degassing region 30 is located opposite the inlet region 24 with respect to the z-direction. In the present case, an interface material 52 is arranged between a respective connection region 26a, 26b and the corresponding partial region 32a, 32b opposite in the z-direction. This can be designed as an adhesive or gap filler.

The degassing channel wall 16 also comprises a predetermined passage point in the form of a predetermined breaking point 34. This is arranged in the inlet region 24 and is located opposite the releasable cell degassing opening 22 with respect to the z-direction. The degassing channel wall 16 can have a wall component 36 which has an opening 38, for example a hole, in the region of the predetermined breaking point 34. In addition, the degassing channel wall 16 can comprise a cover element 40 which is arranged to cover the opening 38.

A heat protection layer 42, for example a heat protection mat, is now arranged in the intermediate space 28 between the inlet region 24 and the degassing region 30. This fills a large part of the gap 28. In addition, with respect to the x-direction, this extends beyond the releasable cell degassing openings 22 and the predetermined breaking points 34 in the degassing channel wall 16, as can be clearly seen in FIG. 1, for example. This heat protection layer 42 is compressed in the z-direction in order to achieve a sealing effect. Advantageously, the battery arrangement 10 is now designed with a pressure element 44, by means of which a locally increased compression of the heat protection layer 42 can be achieved, specifically in a region between a first surface 46 of the inlet region 24 and the first module side 12a, wherein this first surface 46 adjoins the predetermined breaking point 34. The region of increased compression of the heat protection layer 42 is illustrated by dashed lines and designated 48. This region 48 of increased compression preferably completely surrounds a gas passage region 42′ of the heat-protective layer 42, wherein this gas-passage region 42′ represents the region of the heat-protection layer 42, which is located in the z-direction between the releasable cell degassing opening 22 and the directly opposite predetermined breaking point 34, contacting both the predetermined breaking point 34 and the releasable cell degassing opening 22. This therefore represents the region of the heat protection layer 42 which, in the event of gas escaping from the cell 14, is penetrated by the escaping gas, when it enters the cell degassing channel 18 or its interior 20 through the predetermined breaking point 34.

In the present example, this pressure element 44 is provided by an elevation, in particular embossing 50, of the first surface 46 or of the degassing channel wall 16, in particular as an embossing of the wall component 36 in an edge region R surrounding the opening 38. By means of this embossing 50, the heat protection layer 42 is advantageously compressed more strongly locally in the region 48. This means that on the one hand an increased sealing effect of the heat protection layer 42 can be achieved in the regions 48 surrounding the gas passage region 42′, as well as a stiffening of the degassing channel wall in this region. The degassing channel wall 16 can thus basically be formed with a thin sheet metal, which for example provides the wall component 36. The restoring forces acting from the heat protection layer 42 in the direction of the degassing channel wall 16 can be reduced on average by the pressure element 44 without impairing the sealing effect. On the contrary, the sealing effect can even be increased by the local compression in the region 48 of the heat protection layer 42.

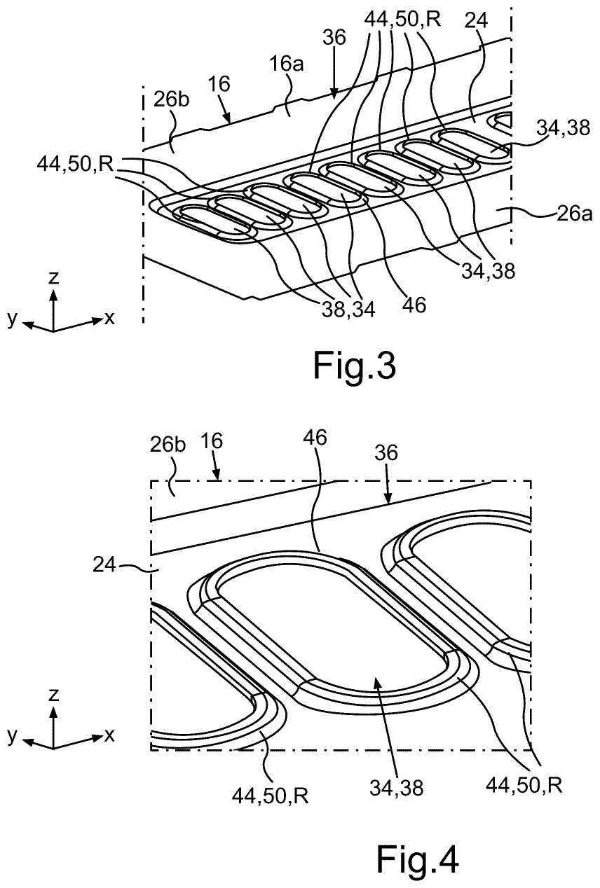

FIG. 3 shows a schematic and perspective illustration of the degassing channel wall 16 for a battery arrangement 10 according to an exemplary embodiment of the invention. The degassing channel wall 16 can be designed as previously described. FIG. 3 shows in particular a perspective view of this degassing channel wall 16 in a plan view obliquely from above onto the first wall side 16a. Furthermore, the degassing channel wall 16 is shown with the wall component 36, but without the cover providing the predetermined breaking points 34 and covering the corresponding openings 38 in the wall component 36. The passage openings 38 in the wall component 36 are oval. In the edge region R of these passage openings 38, a respective pressure element 44 in the form of the described embossing 50 of the wall component 36 is provided.

FIG. 4 again shows an enlarged schematic and perspective view of the wall component 36 of the degassing channel wall 16 in the region of a predetermined passage point 34, for example a predetermined breaking point 34 or a corresponding opening 38 in the wall component 36. This opening 38 is framed by the pressure element 44. The pressure element 44 thus represents an elevated edge region R of this opening 38 or of the predetermined passage point 34. As a result, an increased compressive force can be exerted on the heat protection layer 42 in the z-direction, particularly in an region surrounding the predetermined passage point 34 and directly adjacent thereto, whereby an additional sealing effect can be achieved, particularly around the predetermined passage point 34.

This heat protection layer 42 can thus advantageously provide a protective shield beneath the cells 14, which on the one hand shields the cells 14 from particles and heat in the degassing space 20 and also provides a sealing effect between the cells 14. This compressible protective layer 42 is exposed to a certain contact pressure which is applied by its housing, which in the present case is provided by the first module side 12a in the degassing region 30 on the one hand and the degassing channel wall 16 in the inlet region 24 on the other hand. By locally increasing the compression of the heat protection shield or the heat protection layer 42 by means of the pressure element 44, it is now advantageously possible to avoid the adhesive, as an example of the interface material 52, which is arranged directly next to the heat protection layer 42 with respect to the y-direction, being subjected to excessive shear stress, in particular already during production, for example immediately after the adhesive has been applied, when the adhesive is still hot and is not yet fully cross-linked and has not yet reached its full strength.

Cooling channels 54 can be integrated into the degassing channel wall 16. These are sealed against the interior 20 of the degassing channel 18. As a result, the degassing channel wall 16 can simultaneously provide a cooling device for cooling the battery cells 14. However, the design of the degassing channel wall 16 or the battery arrangement 10 described here is independent of whether the degassing channel wall 16 is designed as a cooling plate or is provided only as a single metal sheet or as a single plate. Likewise, the venting openings, i.e. the releasable cell degassing openings 22, can be designed to be directed upwards and the degassing channel wall 16 and the heat protection layer 42 can be located accordingly above the cells 14.

The heat protection shield 42 is now advantageously not pressed with a high surface region, but mainly only pressed in the region 48 immediately around the vent openings 22, namely by means of the described pressure elements 44. While a large-region pressing, for example over a flat sheet as a degassing channel wall, would lead to high restoring forces and to a high shear stress on the adhesive, as well as to a pressing that is not optimal, especially in the middle of the vent regions 22, the present design of the pressure elements 44, in particular through the formation 50 of the sheet 36 as an example for the wall component 36, around the vent opening 22 of the cell 14, the tightness can be ensured where it is needed, in particular as a local seal. The sheet metal or the wall component 36 of the degassing channel wall 16 is thereby also made stiffer and possible bending is reduced, which in turn results in an improved sealing effect. The shear stress of the adhesive 52 also decreases. This also results in lower costs.

Overall, the examples show how the invention can provide optimized compression of a heat shield in a battery system with no-thermal propagation requirements.

1. A battery arrangement with a heat protection layer, comprising:
a battery module with at least one battery cell which has a releasable cell degassing opening, wherein the battery module has a first module side, wherein a partial region of the first module side represents a degassing region in which the releasable cell degassing opening is arranged; and
a degassing channel wall having a first wall side opposite the first module side with respect to a first direction, which comprises an inlet region opposite the degassing region with respect to the first direction,
wherein the inlet region has a predetermined passage point opposite the cell degassing opening with respect to the first direction, and has a first surface which adjoins the predetermined passage point,
wherein between the degassing region and the inlet region there is an intermediate space in which the heat protection layer is arranged with compression of the heat protection layer with respect to the first direction, and
wherein the battery arrangement comprises at least one linear pressure element which is arranged such that the compression of the heat protection layer is locally increased in the region between the first surface of the inlet region and the first module side.

2. The battery arrangement according to claim 1, wherein the locally increased compression of the heat protection layer caused by the linear pressure element extends along a line which partially or completely surrounds the predetermined passage point, which in particular represents an opening and/or predetermined breaking point in the inlet region.

3. The battery arrangement according to claim 1, wherein the pressure element is designed as an elevation of the first surface of the inlet region.

4. The battery arrangement according to claim 1, wherein the elevation of the first surface is designed as an embossing of the degassing channel wall pointing in the direction of the first module side.

5. The battery arrangement according to claim 1, wherein the elevation of the first surface represents an edge region of the predetermined passage point which continuously surrounds the predetermined passage point.

6. The battery arrangement according to claim 1, wherein the degassing channel wall comprises a wall component, in particular a sheet metal, in which a passage opening is arranged, which is opposite the cell degassing opening with respect to the first direction, wherein the pressure element is designed as an elevation of the first surface that partially or completely surrounds the passage opening, in particular wherein the degassing channel wall has a predetermined breaking cover element, which is arranged on the degassing channel wall such as to cover the passage opening, and the part of which covering the passage opening provides the predetermined passage point in the form of a predetermined breaking point.

7. Battery arrangement according to claim 1, wherein the first wall side has a first and a second contact region, wherein the inlet region is arranged between the first and second contact regions with respect to a second direction which is perpendicular to the first direction, wherein the inlet region is recessed relative to the first and second contact regions with respect to the first direction.

8. The battery arrangement according to claim 1, wherein the pressure element is designed as a linear elevation of a second surface of the heat protection layer.

9. The battery arrangement according to claim 1, wherein the battery module has multiple battery cells with respective releasable cell degassing openings which are arranged in the degassing region of the first module side, wherein the first wall side has an associated predetermined passage point for each cell degassing opening, and wherein the inlet region is divided in a third direction into multiple sub-regions, each of which comprises exactly one of the openings and/or predetermined breaking points, wherein the battery arrangement comprises a linear pressure element for each cell degassing opening, which is arranged such that the compression of the heat protection layer is locally increased in the region between the first surface of a respective sub-region of the inlet region and the first module side.

10. A motor vehicle having a battery arrangement according to claim 1.

11. The battery arrangement according to claim 2, wherein the pressure element is designed as an elevation of the first surface of the inlet region.

12. The battery arrangement according to claim 2, wherein the elevation of the first surface is designed as an embossing of the degassing channel wall pointing in the direction of the first module side.

13. The battery arrangement according to claim 3, wherein the elevation of the first surface is designed as an embossing of the degassing channel wall pointing in the direction of the first module side.

14. The battery arrangement according to claim 2, wherein the elevation of the first surface represents an edge region of the predetermined passage point which continuously surrounds the predetermined passage point.

15. The battery arrangement according to claim 3, wherein the elevation of the first surface represents an edge region of the predetermined passage point which continuously surrounds the predetermined passage point.

16. The battery arrangement according to claim 4, wherein the elevation of the first surface represents an edge region of the predetermined passage point which continuously surrounds the predetermined passage point.

17. The battery arrangement according to claim 2, wherein the degassing channel wall comprises a wall component, in particular a sheet metal, in which a passage opening is arranged, which is opposite the cell degassing opening with respect to the first direction, wherein the pressure element is designed as an elevation of the first surface that partially or completely surrounds the passage opening, in particular wherein the degassing channel wall has a predetermined breaking cover element, which is arranged on the degassing channel wall such as to cover the passage opening, and the part of which covering the passage opening provides the predetermined passage point in the form of a predetermined breaking point.

18. The battery arrangement according to claim 3, wherein the degassing channel wall comprises a wall component, in particular a sheet metal, in which a passage opening is arranged, which is opposite the cell degassing opening with respect to the first direction, wherein the pressure element is designed as an elevation of the first surface that partially or completely surrounds the passage opening, in particular wherein the degassing channel wall has a predetermined breaking cover element, which is arranged on the degassing channel wall such as to cover the passage opening, and the part of which covering the passage opening provides the predetermined passage point in the form of a predetermined breaking point.

19. The battery arrangement according to claim 4, wherein the degassing channel wall comprises a wall component, in particular a sheet metal, in which a passage opening is arranged, which is opposite the cell degassing opening with respect to the first direction, wherein the pressure element is designed as an elevation of the first surface that partially or completely surrounds the passage opening, in particular wherein the degassing channel wall has a predetermined breaking cover element, which is arranged on the degassing channel wall such as to cover the passage opening, and the part of which covering the passage opening provides the predetermined passage point in the form of a predetermined breaking point.

20. The battery arrangement according to claim 5, wherein the degassing channel wall comprises a wall component, in particular a sheet metal, in which a passage opening is arranged, which is opposite the cell degassing opening with respect to the first direction, wherein the pressure element is designed as an elevation of the first surface that partially or completely surrounds the passage opening, in particular wherein the degassing channel wall has a predetermined breaking cover element, which is arranged on the degassing channel wall such as to cover the passage opening, and the part of which covering the passage opening provides the predetermined passage point in the form of a predetermined breaking point.
